(19) United States
(12) Patent Application Publication
(10) Pub. No.: US 2016/0034520 A1
(43) Pub. Date: Feb. 4, 2016

(54) Apparatus and Method for Maintaining and Storing a Log of Status Information

(71) Applicant: Wal-Mart Stores, Inc., Bentonville, AR (US)

(72) Inventors: Donald R. High, Noel, MO (US); Mike Atchley, Springdale, AR (US); Eric E. Welch, Norman, OK (US)

(21) Appl. No.: 14/812,307

(22) Filed: Jul. 29, 2015

Related U.S. Application Data
(60) Provisional application No. 62/030,929, filed on Jul. 30, 2014.

(51) Int. Cl. G06F 17/30

(52) U.S. Cl. CPC G06F 17/30371; G06F 17/30339; G06F 17/30595

(57) ABSTRACT

A control circuit maintains and stores in a memory a log for a retail enterprise of information comprising the current status of various items including data preparation, aggregation of values, execution of statistical models, and development visualizations for each of a plurality of items that are offered for retail sale within the retail enterprise. By one approach the plurality of items represents only a subset of all items that are offered for retail sale by this retail enterprise. By another approach the plurality of items represents all items that are offered for retail sale by this retail enterprise. If desired, the aforementioned log comprises such information for each of a plurality of hierarchical user levels in the retail enterprise.

### RELATED APPLICATION(S)

This application claims the benefit of U.S. Provisional application No. 62/030,929, filed Jul. 30, 2015, which is incorporated by reference in its entirety herein.

### TECHNICAL FIELD

These teachings relate generally to computer-based data processing.

### BACKGROUND

Data mining is known in the art and, generally speaking, pertains to discovering patterns in large data sets. Such processing often includes extracting information from a data set and transforming that information into an understandable structure for further use. Such practices often involve database and data management aspects, data preparation, aggregation of values, the execution of statistical models and/or inference considerations, interestingness metrics, complexity considerations, post-processing of discovered structures, and the development of corresponding visualizations.

Whether the pattern discovery is wholly automated or includes human analysis and consideration, the validity and/or utility of the results can vary with respect to any of a variety of corresponding influences including the freshness of the information. This freshness can pertain to the original underlying data itself and/or downstream processing of such data including aggregation processing and the execution of statistical models that utilize such data.

That said, obtaining needed data and/or maintaining the real-time freshness of all potentially-useful information can overwhelm the computational capacity of a given implementing platform. As a result, at least some information items may only be updated on an occasional/periodic and/or an as-needed basis.

Existing practices in these regards can leave the user uncertain as to the availability and/or freshness of information that is necessary to a particular study. The challenges and uncertainties in these regards can become more pronounced in a hierarchical user setting where different levels of hierarchical user's may have access to different information items.

### BRIEF DESCRIPTION OF THE DRAWINGS

The above needs are at least partially met through provision of the apparatus and method for maintaining and storing a log of status information described in the following detailed description, particularly when studied in conjunction with the drawings, wherein:

FIG. 1 comprises a flow diagram as configured in accordance with various embodiments of these teachings;

FIG. 2 comprises a block diagram as configured in accordance with various embodiments of these teachings; and

FIG. 3 comprises a schematic screenshot as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a control circuit maintains and stores in a memory a log for a retail enterprise of information comprising the current status of various items including data preparation, aggregation of values, execution of statistical models, and development visualizations for each of a plurality of items that are offered for retail sale within the retail enterprise. By one approach the plurality of items represents only a subset of all items that are offered for retail sale by this retail enterprise. By another approach the plurality of items represents all items that are offered for retail sale by this retail enterprise. If desired, the aforementioned log comprises such information for each of a plurality of hierarchical user levels in the retail enterprise.

These teachings are highly flexible in use and will accommodate a variety of modifications and/or extensions. As one example, the control circuit can further serve to present, via a user interface, status information regarding all analytical packages for which all of the information is presently available and sufficiently current. As another example, the control circuit can track and store in the memory metadata regarding the information (where the metadata comprises for example, information identifying when at least some of the items of information were last updated or calculated and/or information regarding at least one of who updated the information and a location where the information was updated). As yet another example, the control circuit can offer a user opportunity (via, for example, the aforementioned user interface) to refresh at least one calculation that is represented by the information.

So configured, such a log can serve to readily advise human users regarding such things as the availability and/or freshness of most or all information items as are presently required to enable a particular data mining exercise. Such information, in turn, can inform and advise the user regarding which, if any, information items should be obtained and/or updated. The present teachings are particularly useful by maintaining a log in these regards for a variety of information items including data preparation, aggregation of values, execution of statistical models, and development visualizations for each of a plurality of items as are offered for retail sale within a given retail enterprise.

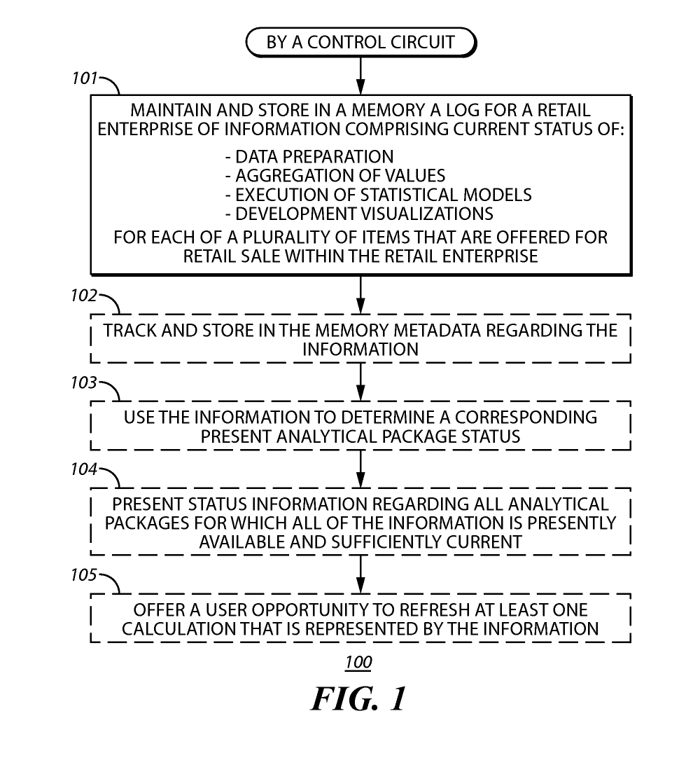

These and other benefits may become clearer upon making a thorough review and study of the following detailed description. Referring now to the drawings, and in particular to FIG. 1, an illustrative process 100 that is compatible with many of these teachings will now be presented.

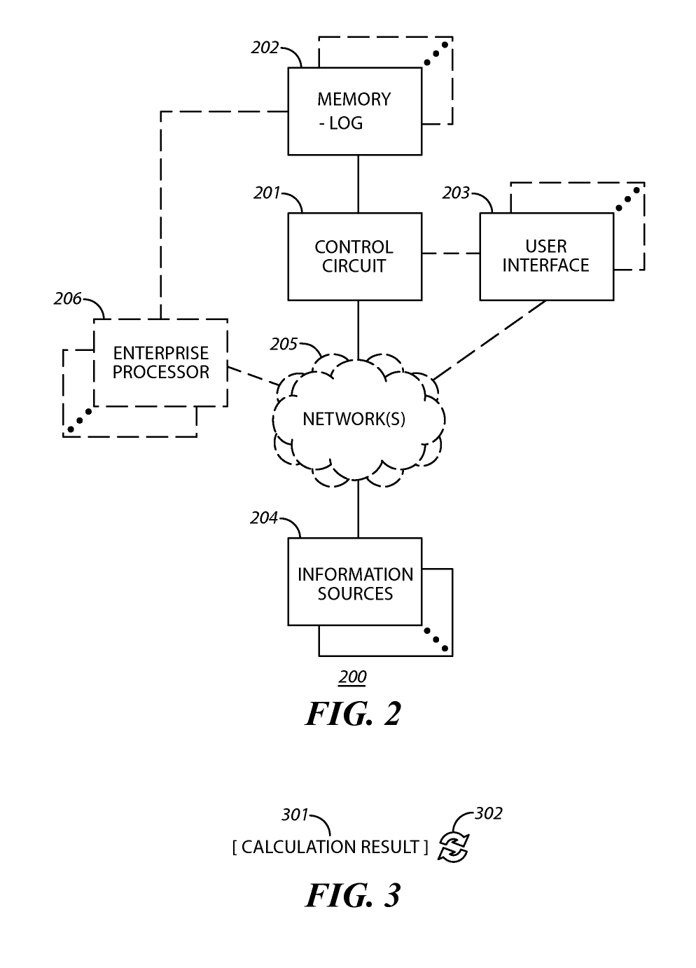

For the purposes of this description it will be presumed that a control circuit of choice carries out the illustrated process 100. Referring momentarily to FIG. 2, such a control circuit 201 can comprise a part of an overall system 200. In such a system the control circuit 201 can operably couple to a corresponding memory 202. Such a control circuit 201 can comprise a fixed-purpose hard-wired hardware platform or can comprise a partially or wholly-programmable hardware platform. These architectural options are well known and understood in the art and require no further description here. This control circuit 201 is configured (for example, by using corresponding programming as will be well understood by those skilled in the art) to carry out one or more of the steps, actions, and/or functions described herein.

The memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

This memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).) As will be described in more detail below, this memory 202 also serves to store a log.

In this illustrative example the control circuit 201 also operably couples to one or more user interfaces 203 and one or more information sources 204. This user interface 203 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user. The control circuit 201 can operably couple to the foregoing elements via a direct (wireless or non-wireless) connection or via one or more intervening networks 205 in accordance with well understood prior art practice in these regards. The network 205 can comprise any of a variety of private and/or public networks including but not limited to various local area networks (LAN's) and/or the Internet.

If desired, this system 200 can also include one or more enterprise processors 206. Such enterprise processors 206 can operably couple to the aforementioned memory 202 (to access, for example, the aforementioned log) and/or to interact with one or more of the aforementioned user interfaces 203.

Referring again to FIG. 1, at block 101 the control circuit maintains and stores in the memory 202 a log. By one approach that log comprises information for each of a plurality of hierarchical user levels in a given retail enterprise (for example, a first hierarchical user level consisting of persons appointed by a Board of Directors, a lower second hierarchical user level of persons who directly report to the first hierarchical user level, and so forth). In any event, this log pertains to information for a given retail enterprise such as a particular retailer or an associated family of retailers (such as a public retail facility that offers goods to the general public under a first brand name and an associated club-membership retail facility that offers goods to members under a second, different brand name, where both brands are controlled by a single overriding retail enterprise).

The log itself can comprise a single, integrated data structure or, if desired, can comprise a virtual construct of a plurality of sub-logs.

The aforementioned log consists of information for the retail enterprise as regards the current status of at least four different informational categories. These informational categories are data preparation, aggregation of values, execution of statistical models, and development visualizations. All of these informational categories are for each of a plurality of items that are offered for retail sale within the retail enterprise. By one approach this plurality of items represents all items offered for retail sale within the retail enterprise. By another approach this plurality of items represents a subset of all items offered for retail sale within the retail enterprise.

To be clear, the log does not include (at least to any great or all-inclusive extent) the data entries for the aforementioned informational categories themselves. Instead, the log contains information regarding the current availability/currency status of such data entries. Accordingly, such information can comprise metadata regarding the data entries. Examples of such metadata include, but are not necessarily limited to, a time/date when each such informational item was last updated and/or calculated/confirmed and/or information regarding at least one of who updated the informational item or a location where the information was updated (such as a particular retail facility, municipality, state or province, country, or other geographical territory of interest).

The aforementioned data preparation shall be understood to refer to raw data and minimally-processed data. Raw data can comprise, for example, current available inventory levels for discrete products (on a stock keeping unit (SKU)-by-SKU basis, for example) at an individual retail sales facility, a list of discrete products that were collectively bought by a consumer in a discrete purchasing event, a time of day when a consumer purchased a given such product, and so forth. These teachings will readily accommodate tracking a large number of data items in these regards. Minimally-processed data can comprise, for example, sales information for such products for a given retail sales facility over some discrete period of time (such as a given twenty-four hour period, a week, and so forth) and the like.

The aforementioned aggregation of values shall be understood to refer to the aggregation of the aforementioned raw data and minimally-processed data (including the aggregation of previously aggregated values). Examples in these regards include, but are certainly not limited to, aggregated sales for an individual retail sales facility for some particular period of time, aggregated sales for all retail sales facilities in a given geographic district, aggregated sales of a particular discrete product at all retail sales facilities for the retail enterprise for some particular period of time, and so forth.

The aforementioned execution of statistical models shall be understood to refer to the calculated results yielded upon executing one or more statistical models using the aforementioned prepared data and/or aggregated values (it being understood that the calculated result of one statistical model can also serve as an input to another statistical model). Those skilled in the art will understand that a statistical model is a formalization of relationships between variables in the form of mathematical equations.

A statistical model describes how one or more random variables are related to one or more other variables. The model is statistical as the variables are not deterministically but stochastically related. A statistical model is a collection of probability distribution functions or probability density functions (collectively referred to as distributions for brevity). A parametric model, for example, is a collection of distributions, each of which is indexed by a unique finite-dimensional parameter. A non-parametric model, on the other hand, is a set of probability distributions with infinite dimensional parameters. And a semi-parametric model, by way of comparison, also has infinite dimensional parameters, but is not dense in the space of distributions.

Statistical models constitute a well understood area of prior art endeavor, as does the execution of such models. Accordingly, for the sake of brevity further elaboration in these regards is not provided here. It will be noted, however, that the control circuit 201 can log the information regarding the execution of a particular statistical model, at least in part, in response to a successful complete execution of a statistical model.

The aforementioned development visualizations shall be understood to refer to at least the background computational processing required to render selected information regarding prepared data, aggregation values, and/or executed statistical model results in a particular displayable format. Depending upon the quantity of information, the nature of the visualization itself, and other factors the time required to effect the computational processing can sometimes be considerable. As used herein, “development visualizations” will be understood to include both static displays as well as dynamic displays that include one or more, for example, animated elements.

By one approach, the control circuit 201 can collect such information pursuant to a collection schedule. By one approach this collection schedule provides for the various information sources 204 to push their respective information in these regards to the control circuit 201. By another approach the control circuit 201 can signal the various information sources 204 to thereby pull such information to the control circuit 201. In lieu of the foregoing or in combination therewith the control circuit 201 can collect such information on a more or less real-time basis. These teachings will accommodate other approaches in these regards if desired.

The log itself can assume any of a variety of formats and data structures as are known in the art. This can include any of a variety of databases (including but not limited to relational databases), spreadsheets, text lists, hypertext transfer markup language (HTML) documents, and so forth as desired. As such approaches are well understood in the art, further elaboration is not presented here for the sake of brevity.

In addition to storing in a log current status information regarding such data, these teachings will accommodate a variety of other related practices as desired. As one illustrative example in these regards, at optional block 102 the control circuit 201 can track and store in the memory 202 metadata regarding such information. Such metadata can comprise, at least in part, information identifying when at least some of the items of information were last updated or calculated and/or information regarding at least one of who updated the information and a physical location where the information was updated.

As another example, at optional block 103 the control circuit can use the aforementioned information to determine a corresponding present analytical package status. An analytical package status, in turn, can comprise a software-based analytical study that makes use of any one or more of the aforementioned items of information (that is, prepared data, aggregated values, executed statistical models, and developed visualizations). As one simple example in these regards, when a given analytical package makes use of information items from all four categories noted above, and all of the information items are current with the exception of one statistical model that was last executed 60 days previously, the control circuit 201 can, for example, determine that this particular analytical package is out of date notwithstanding that most of the available information items are current.

At optional block 104 the control circuit 201 can present status information regarding all analytical packages for which all of the information is presently available and sufficiently current. Such status information can be based, for example, upon the determinations made at block 103. More particularly, by one approach the control circuit 201 can present only analytical packages for which all of the information is presently available and sufficiently current to the exclusion of analytical packages for which all of the information is either presently unavailable and/or not sufficiently current. Using this approach a user can readily consider accessing and/or interacting only with analytical packages that are presently essentially immediately available.

By another approach, these teachings will accommodate displaying both presently available/current analytical packages as well as analytical packages that are not presently available/current due to the unavailability and/or non-current information items. By yet another approach these teachings will accommodate displaying only analytical packages that are presently either unavailable or non-current.

When presenting analytical packages that are, for example, non-current, these teachings will accommodate offering (at optional block 105) a user opportunity to refresh at least one calculation that is represented by the information. FIG. 3 presents a simple illustrative example in these regards. In this example a calculation result 301 (which may constitute a categorical representation or a specific value as desired) is shown via an appropriate user interface 203 in conjunction with an icon 302. By asserting this icon 302 the corresponding calculation can be refreshed (either by the control circuit 201 and/or by an appropriate corresponding information source 204 as appropriate).

So configured, one or more users can leverage the availability of such a log via, for example, one or more enterprise processors 206. In particular, such users can know whether a particular analytical package has valid and current results presently available and, if not, such users can be provided with an opportunity to instigate refreshing the updating of the corresponding information items (including the execution of one or more statistical models as appropriate).

These teachings will accommodate leveraging the contents of such a log for various purposes. By one approach, for example, the log can contain not only the current status information but status information at prior points in time. So configured, such a log will support historically-based analytical studies. As another example, such a log will readily facilitate audits regarding when particular information items were collected, by whom, and from where (as appropriate). As yet another example, the information in such a log could be utilized to facilitate automatically running one or more analysis packages to ensure that particular analysis packages were ready for use/viewing at particular times.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a memory;
a user interface; and
a control circuit operably coupled to the memory and the user interface and configured to:
maintain and store in the memory a log for a retail enterprise of information comprising current status of data preparation, aggregation of values, execution of statistical models, and development visualizations for each of a plurality of items that are offered for retail sale within the retail enterprise.

2. The apparatus of claim 1 wherein the log comprises the information for each of a plurality of hierarchical user levels in the retail enterprise.

3. The apparatus of claim 1 wherein the control circuit is further configured to use the information to determine a corresponding present analytical package status.

4. The apparatus of claim 3 wherein the control circuit is further configured to present, via the user interface, status information regarding all analytical packages for which all of the information is presently available and sufficiently current.

5. The apparatus of claim 1 wherein the control circuit is further configured to track and store in the memory metadata regarding the information.

6. The apparatus of claim 5 wherein the metadata comprises, at least in part, information identifying when at least some of the items of information were last updated or calculated.

7. The apparatus of claim 5 wherein the metadata comprises, at least in part, information regarding at least one of who updated the information and a location where the information was updated.

8. The apparatus of claim 1 wherein the control circuit is further configured to offer a user opportunity, via the user interface, to refresh at least one calculation that is represented by the information.

9. The apparatus of claim 1 wherein the control circuit logs the information regarding the execution of statistical models, at least in part, in response to a successful complete execution of a statistical model.

10. A method comprising:
by a control circuit:
maintaining and storing in a memory a log for a retail enterprise of information comprising current status of data preparation, aggregation of values, execution of statistical models, and development visualizations for each of a plurality of items that are offered for retail sale within the retail enterprise.

11. The method of claim 10 wherein the log comprises the information for each of a plurality of hierarchical user levels in the retail enterprise.

12. The method of claim 10 further comprising using the information to determine a corresponding present analytical package status.

13. The method of claim 12 further comprising presenting, via a user interface, status information regarding all analytical packages for which all of the information is presently available and sufficiently current.

14. The method of claim 10 further comprising tracking and storing in the memory metadata regarding the information.

15. The method of claim 14 wherein the metadata comprises, at least in part, information identifying when at least some of the items of information were last updated or calculated.

16. The method of claim 14 wherein the metadata comprises, at least in part, information regarding at least one of who updated the information and a location where the information was updated.

17. The method of claim 10 further comprising offering a user opportunity, via the user interface, to refresh at least one calculation that is represented by the information.

18. The method of claim 10 further comprising logging the information regarding the execution of statistical models, at least in part, in response to a successful complete execution of a statistical model.
